(19) United States
(12) Patent Application Publication
(10) Pub. No.: US 2014/0012647 A1
(43) Pub. Date: Jan. 9, 2014

(54) APPARATUS, METHODS, AND ARTICLES OF MANUFACTURE FOR VIRTUAL CURRENCY TRANSACTIONS

(71) Applicant: NYZ HOLDINGS INC., Brooklyn, NY (US)

(72) Inventor: NOSON HECHT, WOODMERE, NY (US)

(21) Appl. No.: 13/914,356

(22) Filed: Jun. 10, 2013

Related U.S. Application Data
(60) Provisional application No. 61/660,030, filed on Jun. 15, 2012.

(51) Int. Cl. G06Q 40/04

(52) U.S. Cl. CPC G06Q 40/04
USPC 705/14.23; 705/37

(57) ABSTRACT

In selected embodiments, a computer system implements a virtual currency that can be purchased using a variety of ways, including cash and foreign exchange; wire and similar transfers; trade in of various rewards, airline miles, and unused gift cards; as well as in other ways. Vendors can provide effective discounts and incentives through real time setting of exchange rates between the virtual currency and an existing currency such as legal tender (e.g., dollars), for using the virtual currencies in their stores. The incentive, the fee of the operator of the system, and additional available discounts/coupons may be provided at the point-of-sale.

### CROSS-REFERENCE TO RELATED APPLICATION

The present application claims priority from U.S. Provisional Patent Application Ser. No. 61.1660,030, entitled VIRTUAL CURRENCY PLATFORM, filed on to 15 Jun. 2012, which is hereby incorporated by reference in its entirety as if fully set forth herein, including text, figures, claims, tables, computer program listing appendices if present), and all other matter in the patent document.

### FIELD

This document is related to the field of e-commerce, virtual means of exchange, and virtual store of value.

### BACKGROUND

The e-commerce industry has been growing as a percentage of retail sales over the last decade, with mobile commerce in particular increasing sharply in the last few years. According to some sources, e-commerce sales in 2010 were $572 Billion, with $165B of that coming from the United States. Continued double-digit percentage growth is projected, and 2013 e-commerce sales are expected to increase to $963B globally, the U.S. accounting for approximately one quarter of that. The mobile commerce space, although relatively small, is growing at an astonishing rate—approximately doubling in each of the last two years. Yet despite the growing share of retail sales coming from these nascent platforms, the payment industry has not evolved to offer e-commerce and mobile shopping with adequate convenience for the shopper and the merchant.

Customer acquisition and retention are other areas where improvements are needed. It has become increasingly expensive to acquire a customer, particularly for small to mid-sized vendors. At the same time, customer retention rates have been decreasing, thus reducing the long-term value of each newly-acquired or previously existing customer. It has become expensive for many merchants to compete with the “big guys,” for example, in bidding for popular keywords on pay-per-click advertising platforms. Additionally, advertising budgets may be wasted on platforms where actual users are not shopping in sufficient numbers. It appears, for example, that people use Google predominantly to search for information, and Facebook predominantly to socialize. Because of the shortcomings of these platforms, some vendors have resorted to selling their product through affiliate networks and marketplaces, typically giving away up to fifteen percent of their margins, and sometimes more, often without acquiring long-term customers.

Needs in the art thus exist for better ways to acquire and hold on to customers, to provide improved payment options, and otherwise to facilitate online commerce, mobile commerce, and/or point-of-sale commerce.

### SUMMARY

Selected embodiments described in this document include computer-based social-commerce systems, including systems that enable vendors to reach consumers when the consumers are ready, willing, and able to shop. In embodiments, the systems implement virtual currency trading, and enable provision of consumer discounts through an exchange rating mechanism, wherein the exchange rates are set dynamically, based on various criteria. The social-commerce systems may provide access to the aggregate data on consumer behaviors, and may thus increase long-term customer value.

In an embodiment, a computer-implemented e-commerce method includes exchanging by a computerized trading system stored value of a consumer for virtual currency tokens. The method also includes receiving by the computerized trading system from a remote device an identification of one or more products for purchase by the consumer from a vendor in course of a transaction. The method additionally includes obtaining by the computerized trading system an exchange rate between a legal tender and the virtual currency tokens, the exchange rate being applicable to the transaction, the exchange rate being provided by the vendor or being based on information provided by the vendor. The method further includes computing cost of the transaction to the consumer in the virtual currency tokens based at least on price of each product of the one or more products in the legal tender, and the exchange rate. The method further includes transmitting, the cost of the transaction from the computerized trading system to the remote device. The method further includes receiving by the computerized trading system a notification of a commitment by the consumer to the transaction. The method further includes crediting an account of the vendor with the cost of the transaction less a fee based at least in part on an effective discount received by the consumer as a result of variation in the exchange rate, the step of crediting being performed in response to receiving by the computerized trading system of the notification of the commitment by the consumer to the transaction.

In an embodiment, a computerized trading system includes at least one processor, one or more memory devices coupled to the at least one processor, one or more storage devices coupled to the at least one processor, and one or more network interfaces coupling the at least one processor to at least one network. The one or more memory devices store machine-readable program code. When the at least one processor executes the program code, the at least one processor configures the computerized trading system to exchange stored value of a consumer for virtual currency tokens; receive from a remote device an identification of one or more products for purchase by the consumer from a vendor in course of a transaction; obtain an exchange rate between a legal tender and the virtual currency tokens, the exchange rate being applicable to the transaction, the exchange rate being provided by the vendor or being based on information provided by the vendor; compute cost of the transaction to the consumer in the virtual currency tokens based at least on price of each product of the one or more products in the legal tender, and the exchange rate; transmit the cost of the transaction to the remote device; receive from a computer system of the vendor or from the remote device a notification of to commitment by the consumer to the transaction; and credit an account of the vendor with the cost of the transaction less a fee based at least in part on an effective discount received by the consumer as a result of variation in the exchange rate, in response to receiving by the computerized trading system of the notification of the commitment by the consumer to the transaction.

In an embodiment, an article of manufacture has one or more machine-readable storage devices storing machine-readable computer code. The code includes program steps for exchanging by a computerized trading system stored value of a consumer for virtual currency tokens; receiving by the computerized trading system from a remote device an identification of one or more products for purchase by the consumer from a vendor in course of a transaction; obtaining by the computerized trading system an exchange rate between a legal tender and the virtual currency tokens, the exchange rate being applicable to the transaction, the exchange rate being provided by the vendor or being based on information provided by the vendor; computing cost of the transaction to the consumer in the virtual currency tokens based at least on price of each product of the one or more products in the legal tender, and the exchange rate; transmitting the cost of the transaction from the computerized trading system to the remote device; receiving by the computerized trading system from a computer system of the vendor or from the remote device a notification of a commitment by the consumer to the transaction; and crediting an account of the vendor with the cost of the transaction less a fee based at least in part on an effective discount received by the consumer as a result of variation in the exchange rate, the step of crediting being performed in response to receiving by the computerized trading system of the notification of the commitment by the consumer to the transaction.

These and other features and aspects of selected embodiments will be better understood with reference to the following description, drawings, and appended claims.

### BRIEF DESCRIPTION OF THE FIGURES

FIG. 1 illustrates selected steps of a method of e-commerce using a new means of exchange or virtual currency; and

FIG. 2 is a simplified block diagram representation of a computer-based system configured in accordance with selected aspects of described in this document, for performing the method of FIG. 1.

### DETAILED DESCRIPTION

In this document, the words “embodiment,” “variant,” and “example” refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar expressions and phrases are used to indicate one of a number of different possible embodiments. The number of possible embodiments is not necessarily limited to two or any other quantity. Characterization of an item as “exemplary” (or words to that effect) means that the item is used as an example. Such characterization of an embodiment does not necessarily mean that the embodiment is a preferred embodiment; the embodiment may but need not be a currently preferred embodiment. All embodiments are described for illustration purposes and are not necessarily strictly limiting.

The words “couple,” “connect,” and similar expressions with their inflectional morphemes do not necessarily import an immediate or direct connection, but include connections through mediate elements within their meaning.

“Product” refers to tangible and intangible goods, services, and wares of any kind that may be subject of sale.

The expression “processing logic” should be understood as selected steps and decision blocks and/or hardware for implementing the selected steps and decision blocks. “Decision block” means a step in which a decision is made based on some condition, and process flow may be altered based on whether the condition is net or not met.

When the word “selected” is used with reference to an item (such as a component, embodiment, variant, element, step) and without mention of the specific selection process, the word signifies any one or more, possibly but not necessarily all, of the items available for the purpose described. For example, “selected components of the system include” is used in the sense that other components may be found in the referenced system, and some of the described components may be omitted in some other systems.

Other and further definitions and clarifications of definitions, both explicit and implicit, may be found throughout this document.

Reference will be made in detail to one or more embodiments (apparatus, methods, and/or articles of manufacture) that are illustrated in the accompanying drawings. Same reference numerals may be used in the drawings and this description to refer to the same apparatus elements and method steps. The drawings may be in to simplified form, not to scale, and may omit apparatus elements and method steps that can be added to the described systems and methods, while possibly including certain optional elements, steps, and/or decisions.

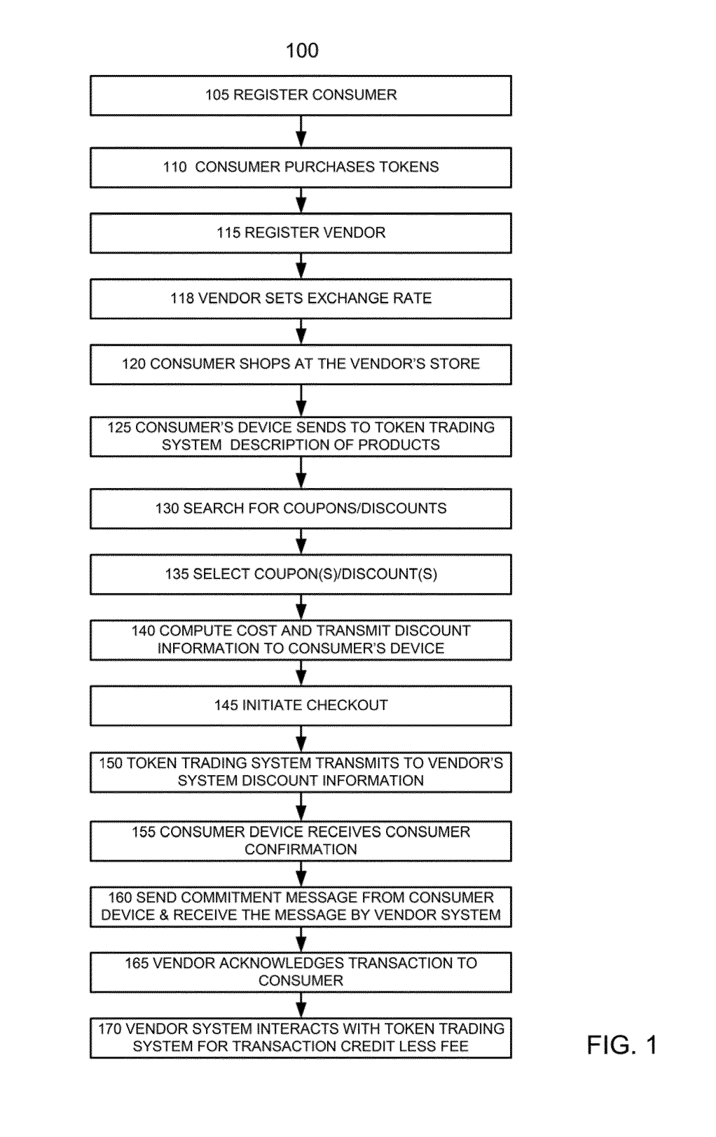

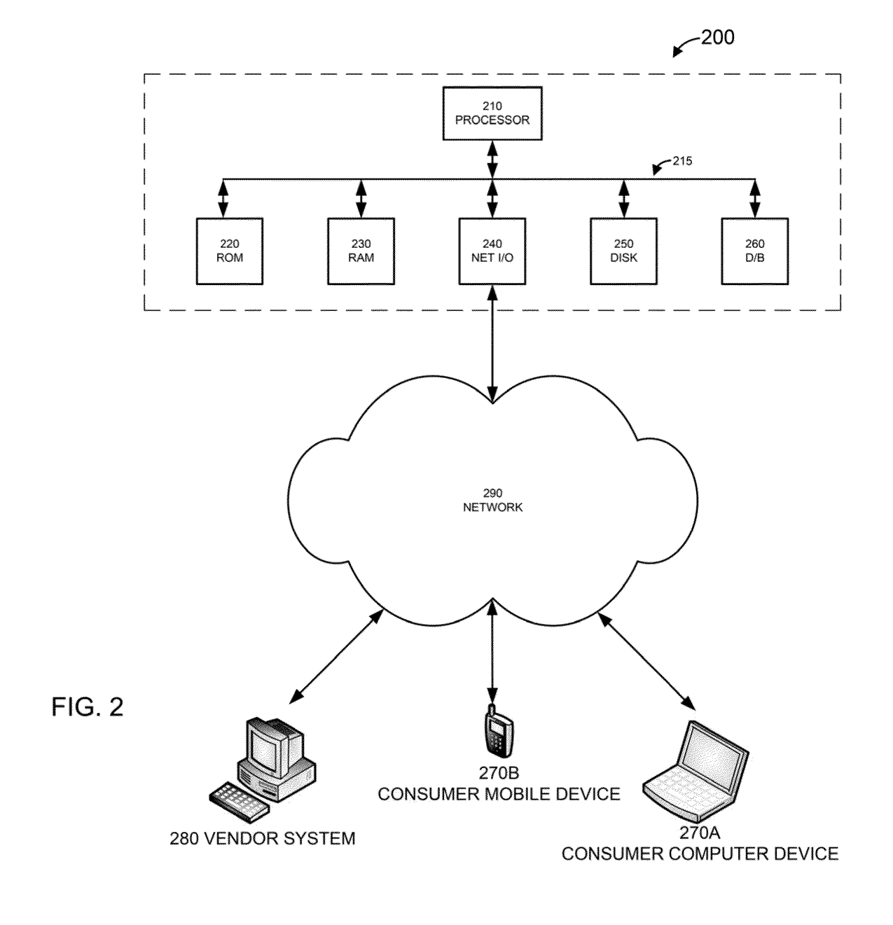

FIG. 1 illustrates selected steps of a method 100 of e-commerce using a new means of exchange or virtual currency, which means of exchange or virtual currency may be referred to as “tokens.” The tokens are not money in the conventional sense, but a different means of exchange. The method 100 may be implemented using a computer system with one or more networked computers configured to perform the steps; the computer system may be referred to as token trading system, and may be configured by the operator of the token trading system. An example of such system is illustrated in FIG. 2 and described in connection with that Figure.

In step 105, a consumer registers with the operator of the token trading system, for example, providing the consumer's name; mailing address, email, and/or other contact information; and descriptions of various affiliations of the consumer (e.g., credit cards, airline frequent flier clubs, reward programs, financial affiliations of the consumer such as bank and credit union affiliations). As part of this step, the consumer's information and identity may be verified, for example, by creating minor activity in the consumer's existing financial or other accounts, and asking the consumer to describe the activity.

In step 110, the consumer “purchases” some amount of the tokens. This “purchasing” may be done, for example, in “exchange” for any kind of “stored value.” The stored value may be provided as a direct payment in currently existing means of exchange (for example, dollars, euros, or other kinds of legal tender/currency), conventional credit, credit from the operator of the token trading system or an affiliated entity, exchange of unused gift cards from various gift card sources, virtual and game credits, reward units, airline miles, an automated clearing house transfer or other wire transfer, physical transfer by mail (particularly in the cases of small amounts of forex left after an overseas trip, and checks), and moneygram.

The consumer may purchase the tokens, for example, directly from the operator of the token trading system, from an entity affiliated with the operator of the system, or otherwise. For airline miles, an exclusive partnership may allow the consumer to convert the partner's miles into the tokens on either the partner's website or the website of the platform operator, or both.

The system may also enable consumers to transfer tokens to each other through mobile number transfers, email, and various social site and similar accounts (such as Facebook and Twitter). “Groups” and “Cause” features may allow consumers to chip-in for gifts or group “pots,” and provide an easy way to raise funds (including the tokens) for charitable contributions and/or other purposes. These are useful features because they enable micro contributions to he made with reduced costs.

Note that providing the capability to exchange foreign currencies into tokens may enable consumers to shop through the token trading system (including websites of any vendors affiliated with the operator of the token trading system), regardless of the consumers' physical locations, and without having to worry about forex exchange rates or logistics. The virtual currency tokens may become a true universal currency for the Internet.

The purchase may be verified and the consumer's account with the operator of the token trading system may then be credited with the purchased tokens. The consumer's funds may be held in an insured account, and the operator of the token trading system may qualify as a money transmitter under Federal regulations.

In step 115, a vendor registers with the operator of the token trading system. This may include receiving from the vendor the vendor's information, as well as executing an agreement between the vendor and the operator. In embodiments, various parameters relating to the interactions between and among the vendor, the operator of the token trading system, and consumers may be programmed into the system. In other embodiments, the parameters may be programmed in a separate step or steps, and/or as part of another step or other steps.

In step 118, the vendor sets or re-sets the rate(s) for purchasing the tokens by a consumer. More than one rate may be set, for different currencies and other means of exchange, such as token/dollar, token/euro, token/reward dollar, token/airline mile. The setting or resetting of the exchange rate(s) may be done, for example, in real time, at periodic intervals (changed by the vendor daily or hourly, for example), other predetermined or random times, and/or automatically in response to various events. The various events may include:

variations in the vendor's supply cost;

variations in the vendor's inventory size;

changes in manufacturer incentive(s) applicable to the product(s) of the transaction between the consumer and the vendor;

financial events, such as interest rate, stock market, forex market, commodity market, and/or bond market movements exceeding a predetermined threshold applicable to the particular market as a whole or one or more of its component securities or trading devices;

the consumer's shopping-related data such as the consumer's viewing or searching for various products, the consumer's recent purchases, products in a shopping cart of the consumer;

personal calendar events, such as births, birthdays, graduations, anniversaries, bar/bat mitzvahs, sweet sixteen celebrations, in the life of the consumer or the consumer's relatives, friends, and/or other people associated with the consumer;

general calendar events such as holidays and similar sale occasions; and

ad hoc “event” decisions by the vendor.

The exchange rate may be specific to the particular consumer or a group of consumers; the exchange rate need not be the same for all consumers. For example, preferred consumers may get preferred rates. Thus, for a given consumer at a given time, a rate of 1.10 (one hundred and ten percent, or a ten percent premium) dollars per token may be established and advertised for purchases from to vendor. For the consumer-vendor transactions occurring at that time, this would be the rate of exchange. Thus, the consumer may have purchased 100 tokens with $100. The consumer can then buy a $110 pair of shoes with 100 tokens, obtaining an effective discount of about 9%(1−100/110)*100)≈9).

The exchange rate(s) may also differ for purchases of different products/services of the vendor; for example, promotional exchange rates may be applied to selected products.

The exchange rate may be received from the vendor; it may also be dynamically computed by the

The system may apply predetermined limits to the vendor's ability to set the exchange rates. The operator of the token trading system may program the limits at the time of configuring the system, and re-program the limits at later times.

As will become more clear from the discussion below, the setting of the exchange rates effectively moves a discount from the product(s) being purchased or the consumer purchasing the product(s) to the instrument of payment.

In step 120, the consumer may shop at the vendor's store, which may be a virtual or a bricks-and-mortar store. The consumer may put goods/services into a virtual shopping cart, or a real shopping cart or otherwise select goods/services for purchase. As noted above, the consumer's exchange rate may be changed by the vendor during the consumer's shopping, for example, in response to the items placed in the shopping cart or otherwise selected with an outward intent to purchase. In embodiments, the exchange rate or the effective discount due to the exchange rate may be displayed to the consumer in real time (e.g., on the communication device the consumer is using for shopping), as the consumer transfers products into the shopping cart.

In step 125, the consumer's shopping device a personal computer, tablet, smartphone, another mobile device) automatically sends a message to the token trading system, describing the product(s) to be purchased. The message may be sent in response to a selection made by the consumer. For example, the message may be sent in response to the consumer clicking or tapping on an appropriately named tab displayed on the shopping device, or making a corresponding gesture. For actual (not online) shopping, the message may be sent by the cash register or a similar device when the consumer is identified at the physical point-of-sale, for example, by reading consumer identification from a card presented by the consumer.

In step 130, the system searches for coupons or other discounts that may be available for the consumer's purchase of the selected product(s). Note that these discounts are in addition to the effective discount due to the exchange rate. The search may be performed in real time. The search may be a generalized search for one or more of the products, alone or in any of the combination of the products (particularly if additional discounts may be available for a combined purchase). The search may also be based on the consumer's individual profile or other information. For example, a discount may be found based on the consumer's age, professional affiliation, buying club affiliation, other affiliations, past purchases from the same vendor or from another vendor, the consumer's subscriptions, the consumer's other demographic information, the consumer's creditworthiness and/or income, the consumer's social status, or any other information useful for targeting consumers for incentives. (The system may receive the consumer's personal information from the consumer at the time of registration of the consumer or at another time; the system may also obtain this information from other sources, such as sources available to companies for the purpose of marketing.) The system may perform the search on the data stored in one or more of its own databases, one or more databases of third parties, the Internet in general, one or more specific websites, and/or other sources of data.

In step 135, the system selects the most advantageous coupon(s) and/or other discount(s) for the purchase. The selection may be based on the immediate cost (lowest cost to the consumer in tokens or in other means of exchange), on the immediate costs in connection with anticipated future transactions (which information may be provided by the consumer during registration or at another tune), on other criteria, or on any combination of discount criteria.

In step 140, the system calculates the immediate cost of the product(s), and transmits the cost and discount information to the consumer's computer, smartphone, or other device. In the case of physical checkout, the system may send the cost and discount information to the checkout terminal.

In step 145, the consumer initiates checkout of the product(s) from the vendor. Note that the product(s) may be physical (e.g., a latte); virtual/digital (e.g., game credits, downloadable media files such as songs/movies); services (e.g., flowers or deli delivery); charitable contributions; microfinance lending contributions; and payments for previously incurred obligations (returning a loan to a friend). These are, of course, mere examples, and their listing does not exclude payments for other reasons.

The checkout may be initiated through appropriate action using, for example, an input function provided by a web browser or a mobile app executing on the consumer's smartphone or another mobile device, or an analogous function of the checkout terminal. The initiation of the checkout may be done through the vendor's website or mobile application, through the token trading system, concurrently or in parallel through both systems, in a pipelined manner through both systems, or otherwise.

In step 150, the system of the platform communicates with the system of the vendor and transmits coupon discount information from the selection step 135, possibly together with the total token price and/or the actual price in dollars or other existing currencies. The communication may be over one or more networks, e.g., the Internet, cellular, WiFi, Bluetooth™, other networks, or network combinations. WiFi and Bluetooth™ are specific examples of radio frequency (RF) networks operating over short distances, which may be 100 meters or less, 10 meters or less, or 1 meter or less.

In step 155, the consumer's device may receive from the consumer an input (such as a selection made through a web browser or an app running on the consumer's smartphone) confirming the consumer's decision to purchase the product(s). In the case of a physical checkout, the consumer may provide this input through the terminal, either directly or by indicating consent to the vendor's cashier who then provides the input to the terminal.

In step 160, which may be performed by the consumer's device or the terminal in response to receiving the input in the step 155, a message is sent via a network connection (e.g., the Internet, cellular, WiFi, Bluetooth, other networks, or network combinations) committing the consumer to the payment for the product(s). The message may be sent to the token trading system, the vendor's system, and/or another system.

In step 165, the vendor's system sends an acknowledgement/receipt to the consumer, confirming that the transaction has been consummated. The acknowledgement/receipt may be sent, for example, to the consumer's device, to the terminal, to an email address, and/or another physical or electronic destination. The vendor's system may send the acknowledgement/receipt directly (e.g., through a short distance RF link such as a WiFi link or Bluetooth® link), through the token trading system, or through another system.

In step 170, the vendor's system interacts with the token trading system to credit the vendor with the token payment by the consumer, less a transaction fee (if applicable). The consumer's token account is debited in the amount of the transaction.

The fee (or, possibly, one of the fees) imposed by the operator of the token trading system for a transaction may be fixed at a predetermined percentage of the discount effected by the exchange rate, for example, one-third of the discount effected by the exchange rate. The fee (for example, one-third of approximately nine percent, three tokens) could be deducted immediately at the point of sale, so the vendor would be credited with the consumer's token payment less the fee. The vendor may thus be enabled to eliminate both the discount to the consumer and the fee (or one of the fees, or a portion of the fee) to the operator of the token trading system, by setting the exchange rate at one dollar per one token. (One third of zero is zero). The numbers in this discussion are, of course, exemplary.

In addition to the revenue accruing to the operator of the token trading system at the point of sale, as described above, additional revenue may be generated by the operator through a fee imposed on vendors for advertising to consumers, membership fees payable by the consumers for the ability to use tokens and/or additional consumer benefits such as free shipping, membership lees imposed on the vendors, fees for additional services provided to the consumers, and fees for additional services built on top of the token trading system (e.g., fees for provision of credit).

In embodiments, tokens are sold to the consumers in the form of gift cards, i.e., real money in exchange for virtual money.

FIG. 2 is a simplified block diagram representation of a computer-based system 200 configured in accordance with selected aspects described herein. As shown in FIG. 2, the system 200 is coupled to portable consumer devices 270A/B and to a vendor system 280 via a communication network 290. FIG. 2 does not show many hardware and software modules of the system 200, and omits several physical and logical connections. The system 200 may be implemented as a special purpose data processor, a general-purpose computer, a computer system, or a group of networked computers or computer systems configured to perform the steps of methods described below. In some embodiments, the system 200 is built on a personal computer platform, such as a Wintel PC, Linux, Unix, or a Mac computer. The personal computer may be a desktop or a notebook computer. In other selected embodiments, the system is a dedicated or a non-dedicated server configured to perform the method steps described in this document.

The exemplary system 200 includes a processor 210, a read only memory (ROM) module 220, a random access memory (RAM) module 230, a network interface 240, a mass storage device 250, and a database 260. These components are coupled together by a bus 215. In the illustrated embodiment, the processor 210 may be a microprocessor, and the mass storage device 250 may be a magnetic disk drive. The mass storage device 250 and each of the memory modules 220 and 230 are connected to the processor 210 to allow the processor 210 to write data into and read data from these storage and memory devices. The network interface 240 couples the processor 210 to the network 290, which may include, for example, the Internet, a cellular network, and WiFi connections. The nature of the network 290 and of the devices that may be interposed between the system 200 and the network 290 determine the kind of network interface 240 used in the system 200. In some embodiments, for example, the network interface 240 is an Ethernet interface that connects the system 200 to a local area network, which, in turn, connects to the Internet. A cellular interface may provide a connection between the network 290 and some or all of the consumer devices 270. As noted above, the consumer devices 280 may include smartphones, iPads, iPods®, other tablets, PCs, and PDAs.

The database 260 may be used for organizing and storing data that may be needed or desired in performing the method steps described in this document, including storing consumer and vendor registration data. The database 260 may be a physically separate system coupled to the processor 210, as illustrated in FIG. 2. In one alternative embodiment, the processor 210 and the mass storage device 250 are configured to perform the functions of the database 260.

The processor 210 reads and executes program code instructions stored in the ROM module 220, the RAM module 230, and/or the mass storage device 250. Under control of the program code, the processor 210 configures the system 200 to perform the steps of the described methods. In addition to the modules 220/230 and the storage 250, the program code instructions may be embodied in machine-readable storage media, such as hard drives, flash drives/cards, floppy diskettes, CD-ROMs, DVDs, and similar devices, as is further elaborated below. The program code may also be transmitted over a transmission medium, for example, over electrical wiring or cabling, through optical fiber, wirelessly, or by any other form of information transmission. The transmission can take place Over it dedicated link between telecommunication devices, or through a wide- or local-area network, such as the Internet, an intranet, extranet, or any other kind of public or private network. In one embodiment, the program code is downloaded to the system 200 through the network interface 240.

The embodiments described above are illustrative and not necessarily limiting, although they or their selected features may be limiting for some claims.

The features described throughout this document may be present individually, or in any combination or permutation, except where presence or absence of specific elements/limitations is inherently required, explicitly indicated, or otherwise made clear from the context.

Although the process steps and decisions if decision blocks are present) may be described serially in this document, certain steps and/or decisions may be performed by separate elements in conjunction or in parallel, asynchronously or synchronously, in a pipelined manner, or otherwise. There is no particular requirement that the steps and decisions be performed in the same order in which this description lists them or the Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts, it should be noted, however, that specific embodiments/variants/examples use the particular order(s) in which the steps and decisions (if applicable) are shown and/or described.

The instructions (machine executable code) corresponding to the method steps of the embodiments, variants, and examples disclosed in this document may be embodied directly in hardware, in software, in firmware, or in combinations thereof. A software module may be stored in volatile memory, flash memory, Read Only Memory (ROM), Electrically Programmable ROM (EPROM), Electrically Erasable Programmable ROM (EEPROM), hard disk, a CD-ROM, a DVD-ROM, or other form of non-transitory storage medium known in the art. Exemplary storage medium or media may be coupled to one or inure processors so that the one or more processors can read information from, and write information to, the storage medium or media. In an alternative, the storage medium or media may be integral to one or more processors.

Having thus described in detail selected embodiments, it is to be understood that the foregoing description is not necessarily intended to limit the spirit and scope of the invention(s).

This document describes the inventive apparatus, methods, and articles of manufacture for implementing a virtual currency system and e-commerce using the system. This was done for illustration purposes. Neither the specific embodiments of the invention(s) as a whole, nor those of their features necessarily limit the general principles underlying the invention(s). The specific features described herein may be used in some embodiments, but not in others, without departure from the spirit and scope of the invention(s) as set forth herein. Various physical arrangements of components and various step sequences also fall within the intended scope of the invention(s). Many additional modifications are intended in the foregoing disclosure, and it will be appreciated by those of ordinary skill in the pertinent art that in some instances some features will be employed in the absence of a corresponding use of other features. The illustrative examples therefore do not necessarily define the metes and bounds of the invention(s) and the legal protection afforded the invention(s).

What is claimed is:

1. A computer-implemented e-commerce method comprising steps of:
exchanging by a computerized trading system stored value of a consumer for virtual currency tokens;
receiving by the computerized trading system from a remote device an identification of one or more products for purchase by the consumer from a vendor in course of a transaction;
obtaining by the computerized trading system an exchange sate between a legal tender and the virtual currency tokens, the exchange rate being applicable to the transaction, the exchange rate being provided by the vendor or being based on information provided by the vendor;
computing cost f the transaction to the consumer in the virtual currency tokens based at least on price of each product of the one cart more products in the legal tender, and the exchange rate;
transmitting the cost of the transaction from the computerized trading system to the remote device;
receiving by the computerized trading system a notification of a commitment by the consumer to the transaction; and
crediting, an account of the vendor with the cost of the transaction less a fee based at least in part on an effective discount received by the consumer as a result of variation in the exchange rate, the step of crediting being performed in response to receiving by the computerized trading system of the notification of the commitment by the consumer to the transaction.

2. A computer-implemented e-commerce method according to claim 1, wherein:
the steps of receiving by the computerized trading system from the remote device the identification of the one or more products, obtaining by the computerized trading system the exchange rate, transmitting the cost of the transaction from the computerized trading system to the remote device, and receiving by the computerized trading system from a computer system of the vendor the notification of the commitment are performed over one or more networks; and
the computerized trading system receives the notification from the remote device or the computer system of the vendor.

3. A computer-implemented e-commerce method according to claim 2, wherein the one or more networks comprise the Internet, and the computerized trading system receives the notification from the remote device.

4. A computer-implemented e-commerce method according to claim 3, wherein the one or more networks further comprise a cellular network.

5. A computer-implemented e-commerce method according to claim 3, wherein the one or more networks further comprise a short distance radio frequency (RF) communication network.

6. A computer-implemented e-commerce method according, to claim 3, further comprising:
step for searching for additional discounts/coupons for the one or more products, to obtain one or more additional discounts/coupons; and
selecting one or more selected discounts/coupons from the one or more additional discounts/coupons;
wherein the step of computing the cost of the transaction is further based on the one or more selected discounts/coupons.

7. A computer-implemented e-commerce method according to claim 6, further comprising:
transmitting over the one or more networks to the computer system of the vendor information describing the one or more selected discounts/coupons.

8. A computer-implemented e-commerce method according to claim 3, wherein the remote device comprises a communication device of the consumer.

9. A computer-implemented e-commerce method according to claim 3, wherein the remote device comprises a smartphone of the consumer.

10. A computer-implemented e-commerce method according to claim 3, wherein the remote device comprises a tablet device of the consumer.

11. A computer-implemented e-commerce method according to claim 3, wherein the remote device comprises a computer of the consumer.

12. A computer-implemented e-commerce method according to claim 3, wherein the remote device comprises a checkout terminal of the vendor.

13. A computer-implemented e-commerce method according to claim 3, further comprising:
debiting an account of the consumer with the cost of the transaction, the step of debiting being performed in response to receiving by the computerized trading system of the notification of the commitment by the consumer to the transaction.

14. A computer-implemented e-commerce method according to claim 3, wherein the exchange rate applicable to the transaction is obtained automatically from the vendor at periodic times.

15. A computer-implemented e-commerce method according to claim 3, wherein the in exchange rate applicable to the transaction is obtained automatically from the vendor at predetermined times.

16. A computer-implemented e-commerce method according to claim 3, wherein the step of obtaining the exchange rate applicable to the transaction is performed automatically in response to shopping-related data of the shopper.

17. A computer-implemented e-commerce method according to claim 3, wherein the step of obtaining the exchange rate applicable to the transaction is performed automatically in response to a change in an incentive applicable to at least one product of the one or more products.

18. A computer-implemented e-commerce method according to claim 3, wherein the step of obtaining the exchange rate applicable to the transaction is performed automatically in response to a financial event.

19. A computer-implemented e-commerce method according to claim 3, wherein the step of obtaining the exchange rate applicable to the transaction is performed automatically in response to a calendar event.

20. A computer-implemented e-commerce method according to claim 3, wherein the step of obtaining the exchange rate applicable to the transaction is performed automatically in response to a variation in supply cost or inventory size of the vendor.

21. A computerized trading system, comprising:
at least one processor;
one or more memory devices coupled to the at least one processor;
one or more storage devices coupled to the at least one processor;
one or more network interfaces coupling the at least one processor to at least one network;
wherein the one or more memory devices store machine-readable program code, and when the at least one processor executes the program code, the at least one processor configures the computerized trading system to:
exchange stored value of a consumer for virtual currency tokens;
receive from a remote device an identification of one or more products for purchase by the consumer from a vendor in course of a transaction;
obtain an exchange rate between a legal tender and the virtual currency tokens, the exchange rate being applicable to the transaction, the exchange rate being provided by the vendor or being based on information provided by the vendor;
compute cost of the transaction to the consumer in the virtual currency tokens based at least on price of each product of the one or more products in the legal tender, and the exchange rate;
transmit the cost of the transaction to the remote device;
receive from a computer system of the vendor or from the remote device a notification of a commitment by the consumer to the transaction; and
credit an account of the vendor with the cost of the transaction less a fee based at least in part on an effective discount received by the consumer as a result of variation in the exchange rate, in response to receiving by the computerized trading system of the notification of the commitment by the consumer to the transaction.

22. An article of manufacture comprising one or more machine-readable storage devices storing machine-readable computer code in a non-transitory manner, wherein the code comprises step of:
exchanging by a computerized trading system stored value of a consumer for virtual currency tokens;
receiving by the computerized trading system from a remote device an identification of one or more products for purchase by the consumer from a vendor in course o a transaction;
obtaining by the computerized trading system an exchange rate between a legal tender and the virtual currency tokens, the exchange rate being applicable to the transaction, the exchange rate being provided by the vendor or being based on information provided by the vendor;
computing cost of the transaction to the consumer in the virtual currency tokens based at least on price of each product of the one or more products in the legal tender, and the exchange rate;
transmitting the cost of the transaction from the computerized trading system to the remote device;
receiving by the computerized trading system from a computer system of the vendor or from the remote device a notification of a commitment by the consumer to the transaction; and
crediting an account of the vendor with the cost of the transaction less a fee based at least in part on an effective discount received by the consumer as a result of variation in the exchange rate, the step of crediting being performed in response to receiving by the computerized trading system of the notification of the commitment by the consumer to the transaction.
